(19) United States
(12) Patent Application Publication
(10) Pub. No.: US 2022/0141093 A1
(43) Pub. Date: May 5, 2022

(54) NETWORK BANDWIDTH APPORTIONING

(71) Applicant: NEWSOUTH INNOVATIONS PTY LIMITED, Sydney, New South Wales (AU)

(72) Inventors: Vijay Sivaraman, Sydney (AU); Hassan Habibi Gharakheili, Sydney (AU); Himal Kumar, Sydney (AU); Sharat Chandra Madanapalli, Sydney (AU)

(21) Appl. No.: 17/431,821

(22) PCT Filed: Feb. 28, 2020
(86) PCT No.: PCT/AU2020/050183

§ 371 Date: Aug. 18, 2021

(30) Foreign Application Priority Data
Feb. 28, 2019 (AU) 2019900655

(51) Int. Cl. H04L 41/0896; H04L 67/63; H04L 41/5009; H04L 43/50

(52) U.S. Cl. CPC H04L 41/0896; H04L 43/50; H04L 41/5009; H04L 67/327

(57) ABSTRACT

A network bandwidth apportioning process executed by an Internet Service Provider (ISP), the process includes: defining a utility function representing, a relationship between allocated bandwidth of a predetermined network traffic class and a deemed utility of the class; determining, for each of the classes of network traffic, a corresponding portion of network bandwidth to be allocated to the class such that the sum of the deemed utilities for the classes is maximised for the determined portions; and apportioning network bandwidth of the ISP between the predetermined classes of network traffic according to the determined portions of network bandwidth. Network bandwidth apportioning further includes classifying each of the packets into predetermined classes of network traffic and allocating network bandwidth to each of the classes according to the determined portion of network bandwidth for the class.

### PRIORITY

This patent application is a national stage application of PCT/AU2020/050183, filed on Feb. 28, 2020, which claims priority to and the benefit of Australian Patent Application No. 2019900655, filed on Feb. 28, 2019, the entire contents of which are incorporated herein by reference.

### TECHNICAL FIELD

The present disclosure relates to the management of network traffic in a communications network such as the Internet, and in particular to a network band-width apportioning system and process.

### BACKGROUND

Network neutrality—the principle that all packets in a network should be treated equally, irrespective of their source, destination or content—remains a principle cherished dearly in the academic community, but is neither mandated nor enforced in much of the world. The USA has seen the most vigorous debate on this topic, with the pendulum swinging one way and then the other every so often, depending on political mood. The underlying problem in the USA remains that there is no competition—more than 60% of households in the USA have a choice of at most two Internet Service Providers (one over a phone line and the other over a cable TV line), which creates public pressure to regulate the ISPs to prevent traffic differentiation. Interestingly, mobile networks in the same country have seen more competition, and hence have been largely exempt from the net-neutrality debates.

In contrast, several other countries in the world have encouraged competition in broadband services, and in some cases have even paid for national broadband infrastructures from the public purse (e.g., Singapore, Australia, New Zealand, Korea, and Japan), which gives subscribers a choice of tens if not hundreds of ISPs to choose from. In the presence of such healthy competition, the inventors believe it would be wrong to impose neutrality on all ISPs because it would force them to provide bland services that compete solely on price; instead, the inventors believe ISPs should be allowed (indeed encouraged) to differentiate their services in unique ways, and the market left to decide how much their offering is worth (and indeed if a net-neutral ISP dominates, so be it).

In view of the above, the inventors have identified a general need for network traffic discrimination that is flexible enough to allow ISPs to innovate and differentiate their offerings, while being open enough to allow consumers to compare these offerings, and rigorous enough for regulators to hold ISPs accountable for the resulting user experience.

It is desired, therefore, to overcome or alleviate one or more difficulties of the prior art, or to at least provide a useful alternative.

### SUMMARY

In accordance with some embodiments of the present disclosure, there is provided a network bandwidth apportioning process executed by an Internet Service Provider (ISP), the process including the steps of:
accessing utility function data representing, for each of a plurality of mutually exclusive predetermined classes of network traffic, a relationship between per-subscriber provisioned bandwidth of the class and a deemed utility of the class;
processing the utility function data to determine, for each of the classes of network traffic, a corresponding portion of network bandwidth to be allocated to the class such that the sum of the deemed utilities for the classes is maximised for the determined portions; and
apportioning network bandwidth of the ISP between the predetermined classes of network traffic in accordance with the determined portions of network bandwidth, wherein the step of apportioning network bandwidth includes the steps of:
   (i) inspecting packets of network traffic to classify each of the packets into a corresponding one of the predetermined classes of network traffic, wherein corresponding multiple different flows of network traffic are aggregated into each of the classes; and
   (ii) for each said class of network traffic, allocating network bandwidth to packets of the class in accordance with the determined portion of network bandwidth for the class.

In some embodiments, the relationships are defined by respective different analytic formulae, and the process includes generating display data for displaying the analytic formulae to a network user and sending the display data to the network user in response to a request to view the analytic formulae.

In some embodiments, the analytic formulae include one or more analytic formulae with one or more of the following forms:

$$\begin{matrix}{U}_{i} = 1 - {e}^{- a ( x - b )} ; & ( i ) \\ {U}_{i} = \frac{1}{( 1 + {e}^{- a ( x - b )} )} ; and & ( ii ) \\ U ( x ) = k \sqrt{x} & ( iii )\end{matrix}$$

In some embodiments, the analytic formulae include analytic formulae according to:

Uᵢ(Xᵢ)=aᵢxᵢ and Uⱼ(xⱼ)=aⱼxⱼ where aᵢ>aⱼ

wherein class-i's bandwidth demand is always met before class-j receives any allocation.

In some embodiments, the predetermined classes of network traffic include a class for mice flows, a class for elephant flows, and a class for streaming video.

In some embodiments, the predetermined classes of network traffic consist of a class for mice flows, a class for elephant flows, and a class for streaming video.

In some embodiments, the plurality of mutually exclusive predetermined classes of network traffic are no more than a few tens in number.

In accordance with some embodiments of the present disclosure, there is provided at least one computer-readable storage medium having stored thereon processor-executable instructions that, when executed by one or more processors, cause the processors to execute the network bandwidth apportioning process of any one of the above processes.

In accordance with some embodiments of the present disclosure, there is provided a network bandwidth apportioning system, including:
one or more network traffic classification components to receive packets of network traffic and classify each of the received packets into a corresponding one of a plurality of predetermined mutually exclusive classes of network traffic; and
one or more bandwidth allocation components to apportion network bandwidth of the ISP between the predetermined classes of network traffic in accordance with portions of network bandwidth determined by processing utility function data representing, for each of a plurality of mutually exclusive predetermined classes of network traffic, a relationship between per-subscriber provisioned bandwidth of the class and a deemed utility of the class, wherein the portions are determined such that the sum of the deemed utilities for the classes is maximised.

In some embodiments, the network bandwidth apportioning system further includes:
a plurality of traffic simulation components to automatically generate different types of network traffic flows in a network to simulate network traffic flows that might be generated by users of the network performing different types of activities; and
a network performance metric generator to generate a plurality of different metrics of network performance based on the simulated network traffic flows.

Also described herein is a network bandwidth apportioning system, including:
a plurality of traffic simulation components to automatically generate different types of network traffic flows in a network to simulate network traffic flows that might be generated by users of the network performing different types of activities; and
a network performance metric generator to generate a plurality of different metrics of network performance based on the simulated network traffic flows.

In some embodiments, the metrics of network performance include one or more of: web page load time, video stalls, and download rate.

In some embodiments, the metrics of network performance include: web page load time, video stalls, and download rate.

In some embodiments, the relationships are defined by respective different analytic formulae, and the system includes a display component to generate display data for displaying the analytic formulae to a network user and send the display data to the network user in response to receipt of a request to view the analytic formulae.

In some embodiments, the analytic formulae include one or more analytic formulae with one or more of the following forms:

$$\begin{matrix}{U}_{i} = 1 - {e}^{- a ( x - b )} ; & ( i ) \\ {U}_{i} = \frac{1}{( 1 + {e}^{- a ( x - b )} )} ; & ( ii ) \\ U ( x ) = k \sqrt{x} ; and & ( iii ) \\ {U}_{i} ( {x}_{i} ) = {a}_{i} {x}_{i} and {U}_{j} ( {x}_{j} ) = {a}_{j} {x}_{j} \\ where {a}_{i} > {a}_{j} ; & ( iv )\end{matrix}$$

where a≠0, k≠0.

### BRIEF DESCRIPTION OF THE DRAWINGS

Some embodiments of the present disclosure are hereinafter described, by way of example only, with reference to the accompanying drawings, wherein:

FIG. 1 is a block diagram of a network bandwidth apportioning system in accordance with an embodiment of the present disclosure;

FIG. 2 is a flow diagram of a network bandwidth apportioning process in accordance with an embodiment of the present disclosure;

FIGS. 3 and 4 are graphs of normalized marginal utility functions for (FIG. 3) a video-friendly ISP (“ISP-1”), and (FIG. 4) a download-friendly ISP (“ISP-2”);

FIGS. 5 and 6 are charts representing the bandwidth share per class for the ISPs of FIG. 1, namely: (FIG. 5) the video-friendly ISP-1, and (FIG. 6) the download-friendly ISP -2;

FIGS. 7 and 8 are screenshots respectively showing a simulation parameter input screen, and a simulation output screen, of a network traffic simulator used to validate the described network bandwidth apportioning system and process (see text for details);

FIGS. 9 to 11 are graphs illustrating the user experience across neutral, video-friendly, and download-friendly ISPs in terms of: (FIG. 9) web page load time, (FIG. 10) video stalls (seconds per minute), and (FIG. 11) download rate (Mbps);

FIG. 12 is a schematic diagram of a network bandwidth apportioning system in accordance with one embodiment of the present disclosure;

FIGS. 13 to 15 are graphs of experimental results showing the average: (FIG. 13) page load time for mice, (FIG. 14) buffer length for videos, and (FIG. 15) download rate for elephant flows;

FIGS. 16 is a screenshot showing the network performance for Youtube (top) and web browsing (bottom);

FIGS. 17 is a screenshot showing the network performance for Netflix (top) and downloads (bottom); and

FIG. 18 is a block diagram of a data processing component of a network bandwidth apportioning system in accordance with an embodiment of the present disclosure.

### DETAILED DESCRIPTION

In order to address the shortcomings of the prior art, the inventors have developed the present disclosure embodied as a network bandwidth apportioning bandwidth apportioning system and process to meet the requirements of the various stakeholders in the following way. For ISPs, the network bandwidth apportioning system and process give flexibility to specify differentiation policies based on any attribute(s), such as content type, content provider, subscriber tier, or any combination thereof. For example, the network bandwidth apportioning system allows prioritizing streaming video over downloads, giving ‘gold’ subscribers a greater share of bandwidth than ‘bronze’ ones, or even restricting certain applications or content. Needless to say, the system's theoretical flexibility will in practice be constrained by the legal and regulatory environment of the region in which it is applied, and ultimately by market forces.

For consumers, the network bandwidth apportioning system described herein allows them to see and compare the policies on offer from the various ISPs, in terms of the number of traffic classes each ISP supports, how traffic streams map to classes, and how bandwidth is shared amongst classes at various levels of congestion. This allows consumers to clearly identify ISPs that better support their specific tastes or requirements, be it gaming or streaming video or large downloads, or indeed non-discrimination. Further, in exposing its policy, the ISP need not reveal any sensitive information about their network (such as provisioned bandwidth) or their subscriber base (such as numbers in each tier).

Lastly, for regulators, the system provides rigor so that the differentiation behaviour during congestion is computable, predictable, and repeatable. Regulators can audit performance to verify that the sharing of bandwidth in the ISP's network conforms to the ISPs' stated discrimination policies.

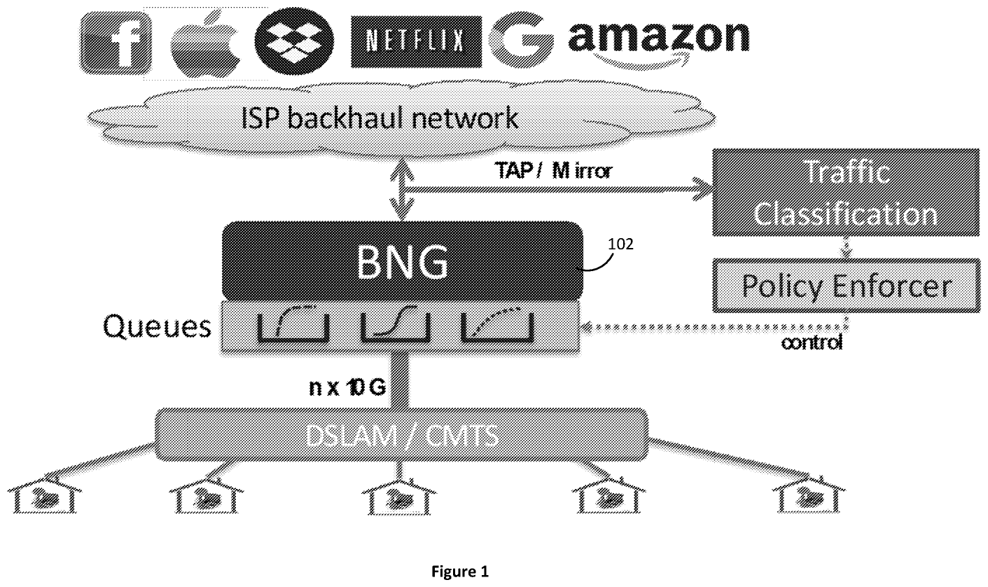

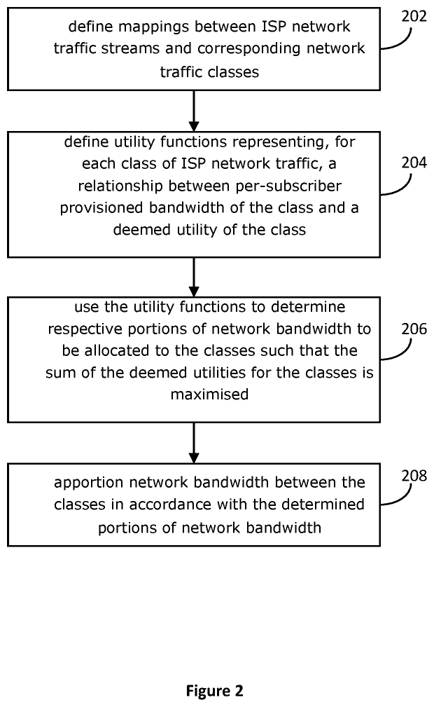

Embodiments of the present disclosure are described herein in the context of a local-exchange/central-office where traffic to/from subscribers (typically a few thousand in number) on a broadband access network (based on DSL, cable, or national infrastructure) is aggregated by one or more broadband network gateways (BNGs) 102, as shown in FIG. 1. This is typically where congestion is most prominent, since in practice the ISP will invariably oversubscribe the capacity available at the BNG 102.

For example, if 5,000 subscribers in an access network aggregated at a BNG 102 are each offered a 20 Mbps plan, the ISP would not provision 100 Gbps of backhaul capacity on the BNG 102, since that would be excessive in cost (for example, at the time of writing the list price of bandwidth on an Australian national broadband network shows that even 10 Gbps capacity at the BNG 102 will cost the ISP A$2 million per-year!). The ISP would therefore rely on statistical multiplexing to provision, say, a tenth of the theoretical maximum required bandwidth in order to save cost, equating to an aggregate bandwidth of 10 Gbps (or 2 Mbps per-user on average). Needless to say, this can cause severe congestion during peak hour when many users are active on their broadband connections.

The features of the network bandwidth apportioning system and process that allow the ISP to deal with this congestion in an open, flexible, and rigorous manner are described below.
Per-Class Queueing and Flow Mapping

The first part of the network bandwidth apportioning process described herein requires the ISP to specify the number of traffic classes (queues) they support at this congestion point, and how traffic streams are mapped to their respective classes. For example, at one extreme, the ISP may have only one (FIFO) class, in which case they are net-neutral. At the other extreme, they may have a class per-user per-application stream (akin to the IETF IntSery proposal); though theoretically permissible, this would require hundreds of thousands of queues, making it infeasible in practice. A pragmatic approach is for the ISP to support a small number (say 2 to 16) of classes—while this may sound somewhat similar to the IETF DiffSery proposal, it should be noted that the number of classes and the mapping of traffic streams to classes is decided by the ISP, and is not mandated by any standard. For example, the ISP may choose to have three classes: one each for browsing, video, and large download streams.

In any case, the ISP has to clearly define the criteria by which traffic flows are mapped to classes. For example, the ISP could specify that flows that transfer no more than 4 MB each (referred to by those skilled in the art as ‘mice’) are mapped to the “browsing” class, flows that carry streaming video (deduced from address prefixes, deep packet inspection, statistical profile measurement, and/or any other technique) map to the “video” class, and non-video flows that carry significant volume (referred to by those skilled in the art as ‘elephants’) are mapped to the “downloads” class. Additional classes can be introduced if and when necessary; for example to have a separate class for video from one or more specific providers, say Netflix. However, such changes need to be openly announced by the ISP, including the mapping criteria, as well as the bandwidth sharing, as described below.

### Bandwidth Sharing Amongst Classes

In order for all stakeholders to obtain the most benefit from the disclosure, the bandwidth sharing amongst classes has to be specified in a way that: (a) is highly flexible so that ISPs can customize their offerings as they see fit; (b) is rigorous so that it is repeatable and enforceable across the entire range of traffic conditions; (c) is simple to implement at high traffic speeds; (d) does not require ISPs to reveal sensitive information including link speeds and subscriber counts; and (e) is meaningful for customers and regulators.

### Open Traffic Differentiation

In work leading up to the disclosure, the inventors rejected several possible bandwidth sharing arrangements, including simplistic ones that specify a minimum bandwidth share per-class (as it may be variable with total capacity, and is ambiguous when some classes do not offer sufficient demand), and complex ones (like in IntServ/DiffServ) requiring sophisticated schedulers. Instead, the network bandwidth apportioning system and process described herein use utility functions to optimally partition bandwidth. Specifically, each class of network traffic is associated with a corresponding utility function that represents the “value” of bandwidth to that class, as determined by the ISP. Though utility functions have been discussed in the networking literature, they usually start with the bandwidth “needs” of an application (voice, video or download) stream, and attempt to distribute bandwidth resources to maximally satisfy application needs. By contrast, the network bandwidth apportioning process described herein flips the viewpoint by having the ISP determine the utility function for a class, based on their perceived value of that traffic class in their network. Stated differently, the utility function for each class is a way for the ISP to state how much they value that class at various levels of resourcing. As shown below, the use of utility functions gives ISPs high flexibility to customise their differentiation policy, protects sensitive information, and is simple to implement, while consumers and regulators benefit from open knowledge of the ISP's differentiation policy that they can meaningfully compare and validate.

[44] An optimal partitioning of a resource (aggregate bandwidth in this case) between classes is deemed to be one in which the total utility is maximized. Stated mathematically, let dᵢ denote the traffic demand of class-i, and Uᵢ (xᵢ) its utility when allocated bandwidth xᵢ. For a given capacity C, the objective then is to determine xᵢ that maximizes Σᵢ Uᵢ (xᵢ), where Σᵢ xᵢ=C and ∀ᵢ: xᵢ≤dᵢ. Methods for determining this numerically are available in the literature—in particular, a simple approach to compute optimal allocations is by taking the partial derivative of the utility function, ∝Uᵢ/∝xᵢ, also known as the marginal utility function, and distributing bandwidth amongst the classes such that their marginal utilities are balanced.

### Bandwidth Sharing

As described above, the per-class utility function in the described embodiments is defined by the ISP, not by the consumer or the application. This then begs the question of how an ISP chooses the utility functions, and how a consumer interprets them. It should be noted that a general feature of the system and process described herein is that many different flows of network traffic are aggregated into each of the classes, which are relatively few in number. For example, in any hour there may be many (e.g., typically from at least thousands to several hundreds of thousands) of different network traffic flows, but these are typically aggregated into at most a few tens (e.g., 40) of different classes, and more typically at most ten, and in the examples described below, only three, corresponding to the three major types of network traffic of most interest to most consumers.

Some simple example policies will first be described. In one example, an ISP wants to implement a pure priority system wherein class-i gets priority over class-j. The ISP can then choose respective utility functions Uᵢ (xᵢ)=aᵢxᵢ and Uⱼ (xⱼ)=aⱼxⱼ where aᵢ>aⱼ. This ensures that the marginal utility ∝U/∝x is always higher for class-i than class-j, and class-i's bandwidth demand is therefore always met before class-j receives any allocation.

In a second example, the ISP wants to divide bandwidth amongst the classes in a given proportion: for example, browsing gets 30% of bandwidth, video 50%, and downloads 20%. Then the ISP can choose utility functions of the form Uᵢ (xᵢ)=\sqrt{aᵢxᵢ}, which ensures that the marginal utilities of the classes are balanced when aᵢ/xᵢ is the same for each class, namely when bandwidth for class-i is proportional to aᵢ.

The flexibility of using utility functions as described herein allows the network bandwidth apportioning system and process to accommodate a much wider variety of bandwidth allocation arrangements than the simple examples described above. For example, consider the three traffic classes—browsing, video, and downloads, and develop utility functions that are meaningful to consumers. In order to keep information on provisioned bandwidths (both aggregate and per-consumer) private, the ISP publicly releases a scaled version of these functions, namely one in which the provisioned backhaul capacity is divided by the number of subscribers multiplexed on that link. Using the example of a link (provisioned at say 10-20 Gbps) that serves 5000 subscribers,

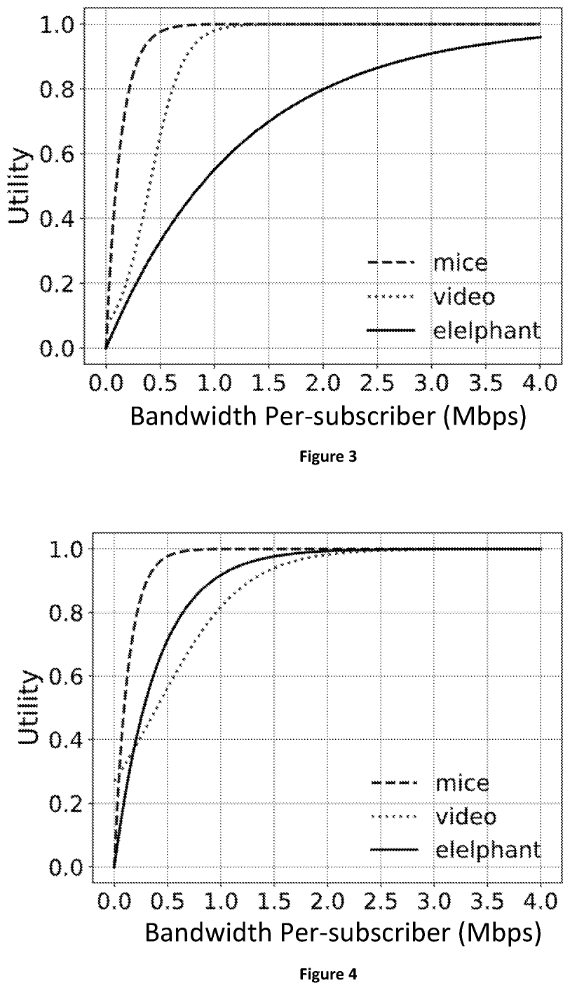

FIG. 3 is a graph showing the scaled utility functions for a “video-friendly” ISP-1 that uses the following utility functions for the three respective classes (mice, video, and elephants):

Uₘ=1−e^{-1.5x}; Uᵥ=1/(1+e^{-1.3(x-2.0)}); Uₑ=1−e^{0.16x} (1)

and FIG. 4 is a graph showing the utility functions for a “download-friendly” ISP-2 that uses the following utility functions for mice, video, and elephants, respectively:

Uₘ=1−e^{-1.5x}; Uᵥ=1/(1+e^{-0.5(x-2.0)}); Ue=1−e^{0.50x} (2)

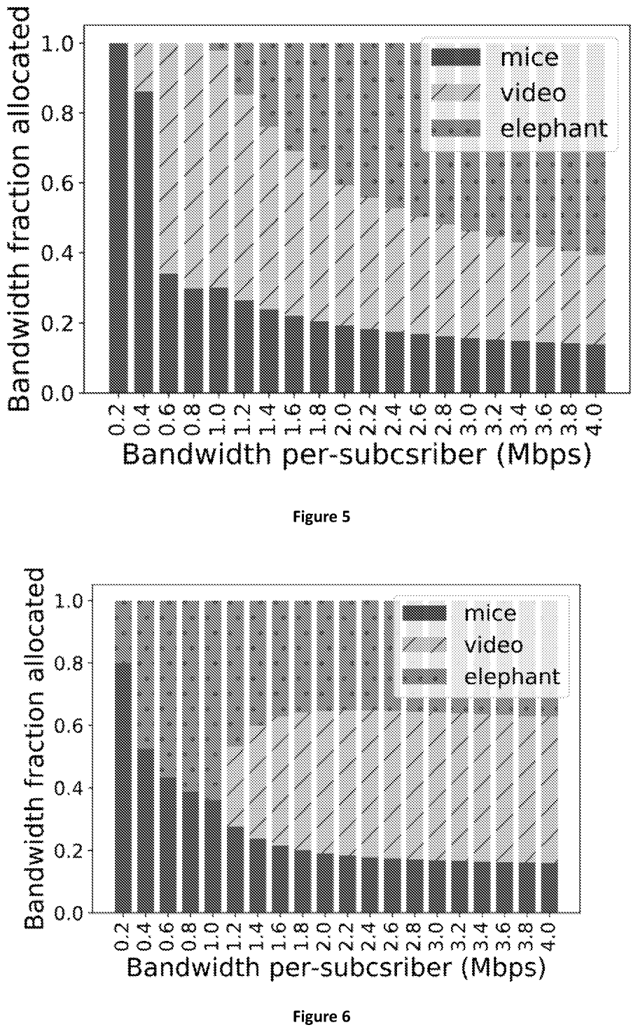

Comparison of the utility functions of Equations (1) and (2) as shown in FIGS. 3 and 4 reveals that ISP-1 values video more at low bandwidths than ISP-2, while ISP-2 conversely values downloads more than video at low bandwidths. At higher bandwidths (in particular at about 4 Mbps per-subscriber and above), the differences in utility become far less significant. This is indeed borne out by the corresponding band-width allocation as a function of provisioned bandwidth per-subscriber, as shown in FIGS. 5 and 6, when each class offers sufficient demand. FIG. 5 shows that ISP-1 prioritizes video over downloads if the bandwidth provisioned per-subscriber is 2.0 Mbps or lower, whereas ISP-2 prioritizes downloads over video over this range as shown in FIG. 6. However, as the provisioned bandwidth per-customer increases, the allocation becomes more balanced across the classes for both ISPs—indeed, when the band-width per-subscriber approaches a large value, each ISP gives each class a third of the total bandwidth. It is important to note that the ISP is not required to reveal the per-subscriber bandwidth at their aggregation point, as this is commercially sensitive information. Also, the average bandwidth provisioned per-user of 2-4 Mbps is similar to the actual per-user provisioned bandwidth of some ISPs, as they rely on statistical multiplexing whereby only a fraction of users are active at any point in time. Further, the same utility functions can be applied to any link in the ISP network by scaling them to the total bandwidth provisioned on that link.

### Measuring User Experience

An idealized simulator was built to evaluate the impact of the network bandwidth apportioning system and process on user experience. A single link at the BNG 102 that aggregates multiple subscribers over the access network was considered, wherein each traffic flow is classified into one of multiple queues, and bandwidth is partitioned between the classes based on their respective utility functions. Traffic is modelled as a fluid, and the simulation progresses in discrete time slots. In each time slot, each active flow submits its request (i.e., the number of bits it wants transferred in that slot); the requests are aggregated into classes, allocations are made to each class in a way that maximizes overall utility for the given demands, and the bandwidth allocated to each class is shared evenly amongst the active flows in that class.

Each flow implements standard TCP dynamics to adjust its request for the subsequent time slot based on the allocation in the current slot: if the request is fully met, it increases its rate (linearly or exponentially, depending on whether it is in the congestion-avoidance or slow-start phase), whereas if the request is not fully met, it reduces its rate (by half or to one MSS-per-RTT, depending on the degree of congestion determined by whether the allocation is at least half of its request or not). Further, the rate of any flow is limited by its access link capacity. While the fluid simulation model does not fully capture all the packet dynamics and variants of TCP, it captures its essence, and allows the simulation of large workloads quickly and with reasonable accuracy.

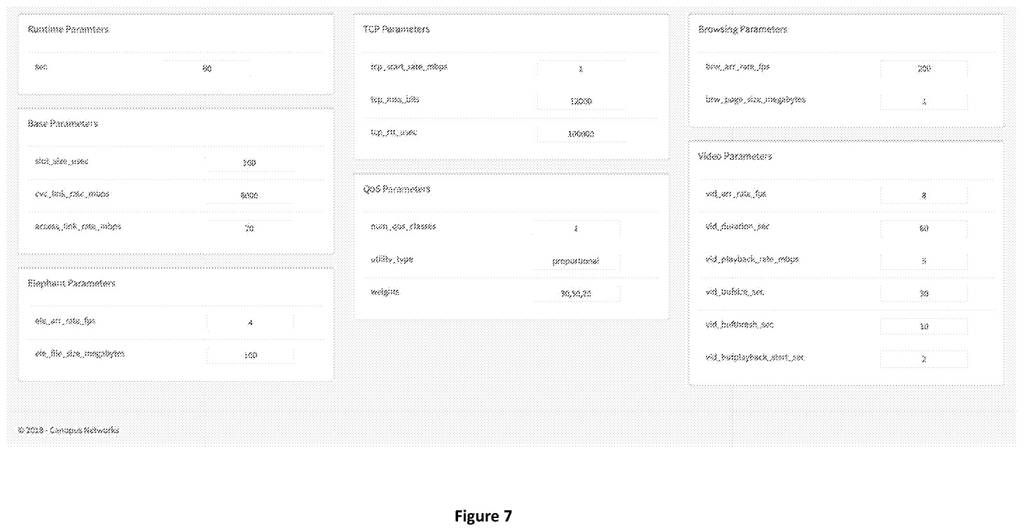

The simulation parameters are adjusted using the graphical user interface (GUI) shown in FIG. 7, and in the described example were chosen as follows: the access links had capacity uniformly distributed in the range of [10,30 ] Mbps, and were multiplexed at a link whose capacity was provisioned in the range of [5, 6 ] Gbps. The simulation slot size was set to 100 μsec, TCP MSS (maximum segment size) to 1500 bytes, and RTT (round-trip delay time) was distributed uniformly in the range [150, 250 ] msec. Network traffic representative of 3000 subscribers was simulated, comprising: browsing flows arriving at 200 flows/sec and loading a web-page exponentially distributed in size with mean size 1 MB; elephant flows arriving at 4 flows/sec with an exponentially distributed download volume of mean value 100 MB; and video flows arriving at 4 flows/sec at HD quality, with a playback rate of 5 Mbps and a playback buffer replenished by an underlying TCP process; further, the playback buffer holds up to 30 seconds of video, is replenished when occupancy falls below 10 seconds worth, and play-back starts as soon as 2 seconds worth of video is ready in the buffer. While this simulated behavior of video streams is simplistic, it nevertheless captures the dynamics of real streaming video from providers such as Youtube and Netflix to a reasonable degree of approximation. These simulation parameters provide a traffic mix of about 28% browsing, 38% video, and 34% downloads, which is reasonably consistent with the mix that the inventors have observed in operational networks.

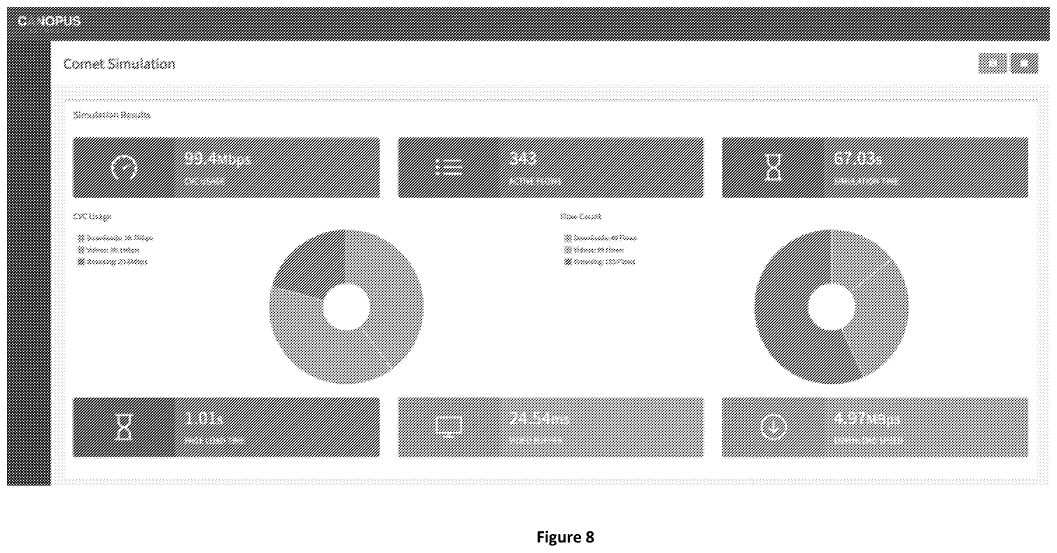

The following three metrics were used to quantify user experience: page-load time, also referred to as ‘average flow completion time’ (“AFCT”) in seconds for browsing flows; playback stalls (in seconds per minute) for streaming video flows; and mean rate (in Mbps) for elephant/download flows. These are displayed continuously by the simulation process via the user interface shown in FIG. 8. The base case for the simulation is a net-neutral ISP-0 that has only a single traffic class, and provisions bandwidth in the range of 5-6 Gbps to serve the 3000 subscribers. This is compared to a video-friendly ISP-1 that uses utility functions: Uₘ(Xₘ)=\sqrt{0.4xₘ}, Uᵥ (xᵥ)=\sqrt{0.5xᵥ} and U(xₑ)=\sqrt{0.1xₑ} for mice, video, and elephant classes respectively, in essence assigning them bandwidth in the ratio of 4:5:1, and a download-friendly ISP-2 that uses utility functions Uₘ(Xₘ)=\sqrt{0.4xₘ}, Uᵥ (xᵥ)=\sqrt{0.3xᵥ} and U(xₑ)=\sqrt{0.3xₑ}, yielding a bandwidth ratio of 4:3:3.

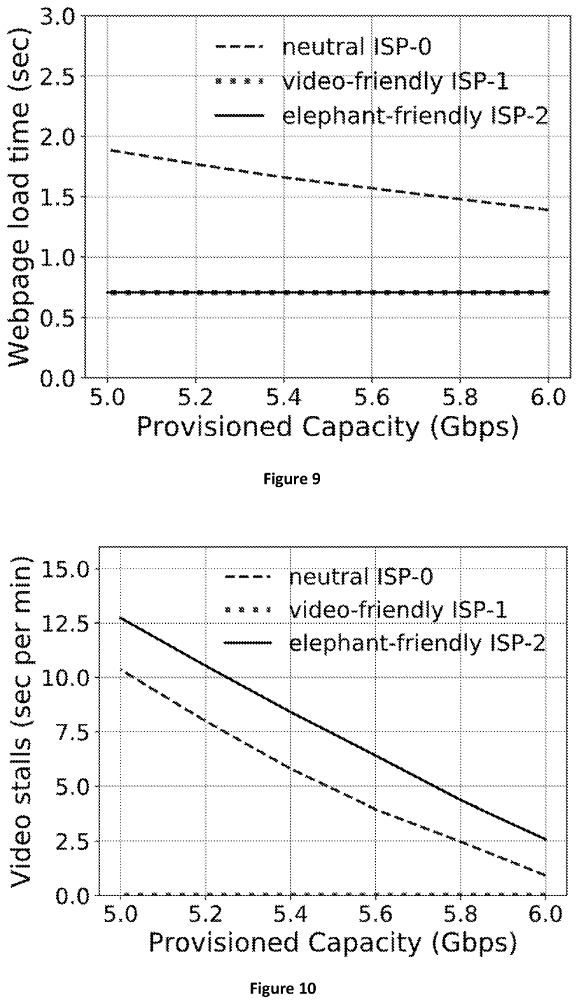

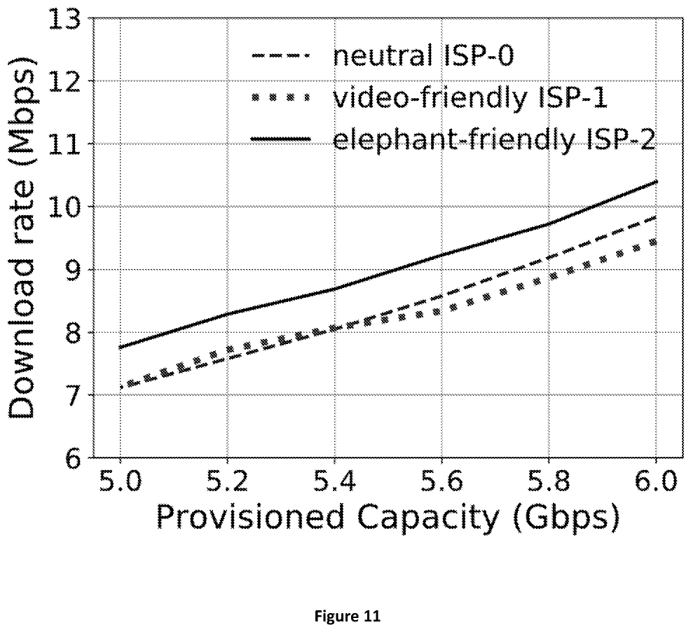

FIGS. 9 to 11 depict the measured user-experience metrics as a function of provisioned bandwidth (in Gbps) for the three ISPs. FIG. 9 shows that the web-page load time is improved at 0.71 sec with ISP-1 and ISP-2, relative to the neutral ISP-0 where mice flows intermix with video and downloads to inflate load times to 1.39-1.89 seconds. Video traffic experiences stalls of 0.92-10.36 seconds on average with ISP-0, as shown in FIG. 10, whereas ISP-1 eliminates stalls by virtue of giving higher utility to the video class, and ISP-2 degrades video by allowing stalls of 2.58-12.73 seconds on average per minute of video play. Conversely, download rates are higher in the download-friendly ISP-2 (7.76-10.39 Mbps), and lower in the video-friendly ISP-1 (7.139.45 Mbps) compared to the neutral ISP-0 (7.12-9.83 Mbps), as shown in FIG. 11. This confirms that the ISP's publicly stated utility functions are corroborated in the resulting user experience, and the network bandwidth apportioning system and process described herein therefore empower ISPs to adjust their class utility functions to differentiate their offerings in the market.

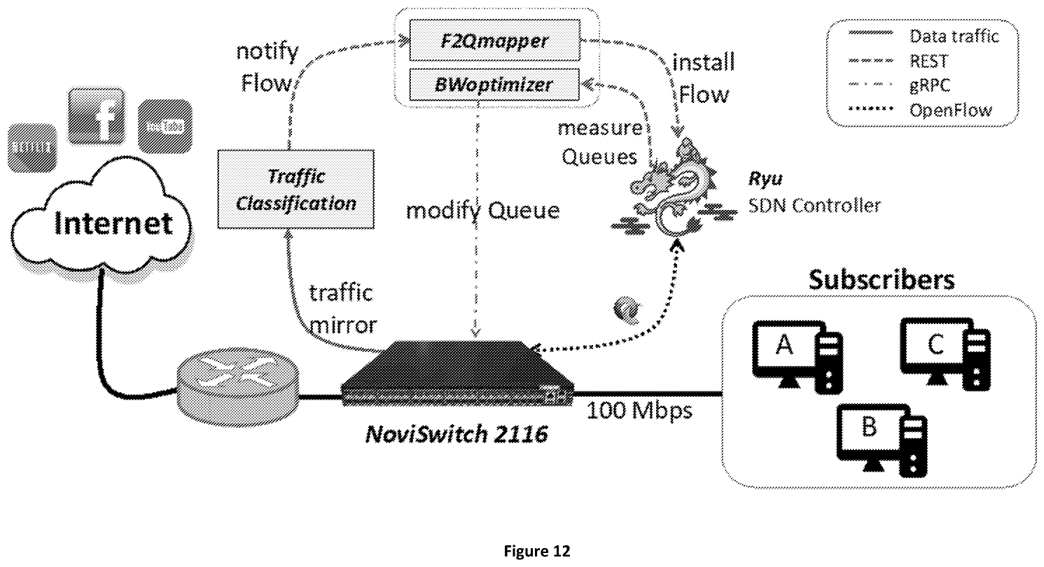

FIG. 12 is a block diagram of an embodiment of a network band-width apportioning system in an SDN (software-defined networking) testbed. The BNG was implemented as a NoviSwitch 2116 SDN switch controlled by a Ryu SDN controller, and connects subscribers to the Internet via the campus network of the University of New South Wales, providing a total capacity of 100 Mbps at the BNG. Three standard personal computers running an Ubuntu 16.04 operating system were used to represent respective broadband subscribers—A, B, and C. A traffic generator tool (written in Python by the inventors) was installed on each computer. Three classes of traffic, namely mice, video, and elephant were considered: mice flows were generated by fetching a set of webpages using the requests library in Python; elephant flows were generated using the wget Unix download tool; and video flows were generated by playing YouTube and Netflix videos in a Chrome browser automated using the Python Selenium library. The traffic generator tools also generate performance metrics (i.e., webpage load time for mice, buffer health and stalls for videos, download rates for elephants) for traffic streams running on each of the personal computers. Flows associated with each class were aggregated using the OpenFlow group entry on the SDN switch—each group is mapped to a corresponding queue.

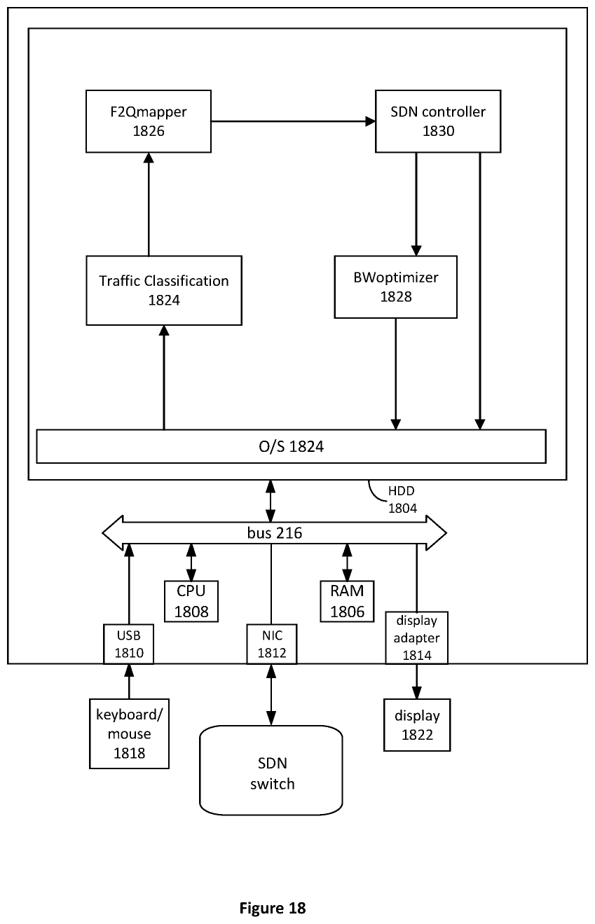

In the described embodiment, the network bandwidth apportioning process is implemented as executable instructions of software components or modules 1824, 1826, 1828 stored on non-volatile storage 1804, such as a solid-state memory drive (SSD) or hard disk drive (HDD), of a data processing component, as shown in FIG. 18, of the network bandwidth apportioning system, and executed by at least one processor 1808 of the data processing component. However, it will be apparent to those skilled in the art that at least parts of the network bandwidth apportioning process can alternatively be implemented in other forms, for example as configuration data of a field-programmable gate arrays (FPGA), and/or as one or more dedicated hardware components, such as application-specific integrated circuits (ASICs), or any combination of these forms.

In the described embodiment, the data processing system includes random access memory (RAM) 1806, at least one processor 1808, and external interfaces 1810, 1812, 1814, all interconnected by at least one bus 1816. The external interfaces include at least one network interface connector (NIC) 1812 which connects the data processing system to the SDN switch, and may include universal serial bus (USB) interfaces 1810, at least one of which may be connected to a keyboard 1818 and a pointing device such as a mouse 1819, and a display adapter 1814, which may be connected to a display device such as a panel display 1822.

The data processing system also includes an operating system 1824 such as Linux or Microsoft Windows, and an SDN or ‘flow rule’ controller 1830 such as the Ryu framework, available from http://osrg.github.io/ryu/. Although the software components 1824, 1826, 1828 components and the flow rule controller 1830 are shown as being hosted on a single operating system 1824 and hardware platform, it will be apparent to those skilled in the art that in other embodiments the flow rule controller may be hosted on a separate virtual machine or hardware platform with a separate operating system.

The software components 1824, 1826, 1828 were written in the Go programming language and are as follows:
(i) “Traffic Classification” 1824, which identifies the class of a traffic flow in real-time, outputting its corresponding 5-tuple and class;
(ii) “F2Qmapper” 1826, which makes a REST call to the Ryu SDN controller, mapping the identified flow to its appropriate queue (via group entry); and
(iii) “BWoptimizer” 1828, which periodically computes the maximum rate of each queue according to its utility curve, given the real-time measurement of demand in each queue (class), and modifies the queue's rate using a gRPC call.

Unfortunately, the NoviSwitch 2116 SDN switch only allows its queue rates to be modified in steps of 10 Mbps. Consequently, a simple utility curve with a square root function (i.e. U(x)=k\sqrt{x}) was employed so that the bandwidth allocations become proportional to \sqrt{k}. For example, if an ISP wants to allocate a fixed fraction of the capacity to each class say rₘ, rᵥ, rₑ then their parameter k respectively becomes \sqrt{rₘ}, \sqrt{rᵥ}, \sqrt{rₑ}.

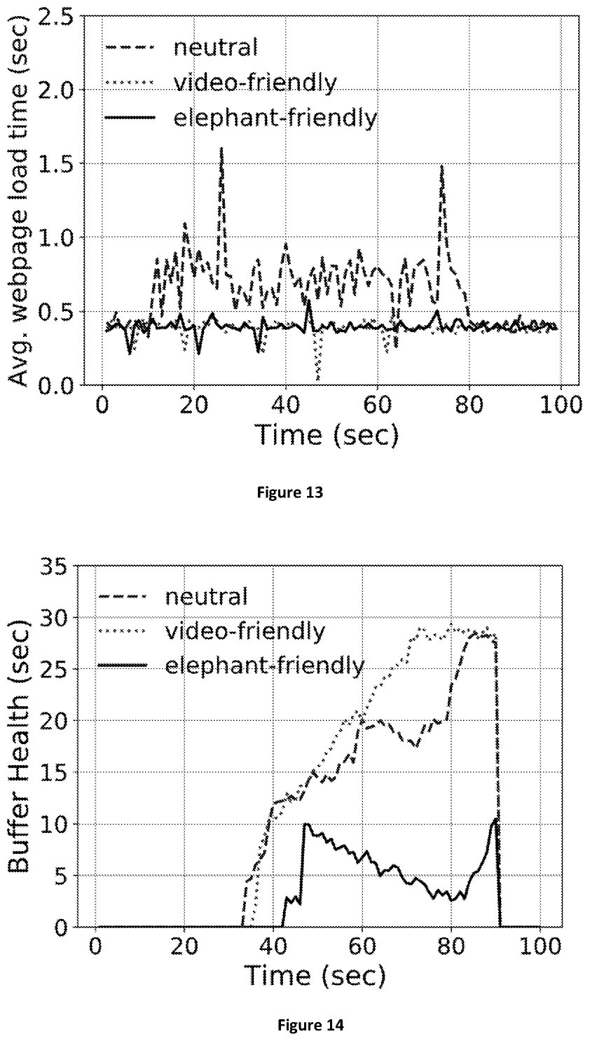

Three scenarios were tested, namely: a neutral ISP, a video-friendly ISP, and an elephant-friendly ISP, with each run lasting for 100 seconds. In all tests, the network traffic was generated so that computers A, B, and C respectively emulate browsing-heavy, download-heavy and video-heavy subscribers. At time 1s, mice flows begin on A. At 10s, computer B starts four downloads (that run concurrently until 80s). The traffic mix remains elephant and mice until 30s when computer C plays a couple of 4K videos on Youtube until 90s. FIGS. 13 to 15 depict respective average performance metrics for each class (of subscriber). The neutral ISP imposes no differentiation to the traffic. The video-friendly ISP allocates bandwidth to mice, video and elephant classes in a ratio of 3:5:2, respectively, and the elephant-friendly ISP allocates in the ratio of 3:2:5. Both of these ISPs use utility functions of the form Uᵢ(x₁)=\sqrt{aᵢxᵢ}.

FIG. 13 shows that the web-page load time is the worst in a neutral scenario (shown by dashed lines). This is due to the high demand from both video and elephant flows that aggressively consume the link bandwidth. In contrast, both video-friendly and elephant-friendly ISPs offer a consistent browsing experience, with a 50% reduction in the average load time compared to the neutral ISP, since 30% of the total capacity is provisioned to mice flows during congestion.

The performance of video flows (in terms of average buffer health) is shown in FIG. 14. In the neutral scenario, videos are affected by the heavy load from elephants, and are unable to reach peak buffer capacity until the elephant flows stop at 80s. The video-friendly ISP, on the other hand, ensures that videos get good experience by limiting the downloads during congestion periods. The video experience on an elephant-friendly network would not be great, as expected—nevertheless, an increase in buffer capacity is observed after the downloads have stopped.

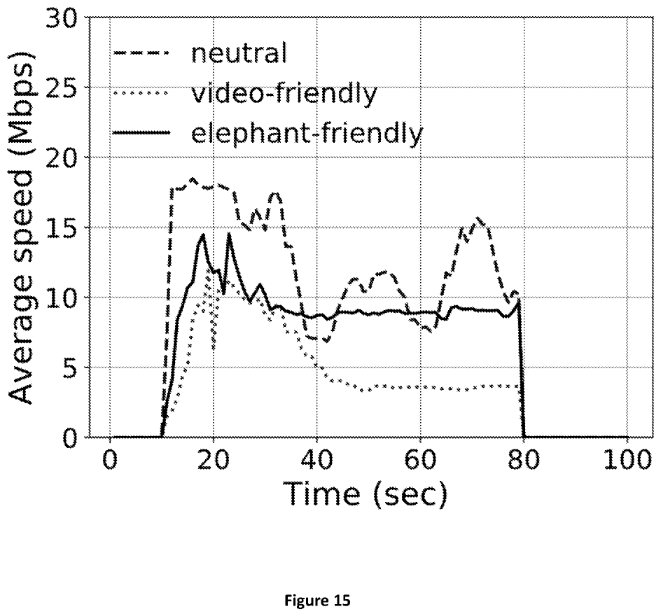

Lastly, elephants perform the best in the neutral scenario, causing mice and videos to suffer, as shown in the graph of average download speed of FIG. 15, although the download speed fluctuates significantly upon the commencement of video streaming. Downloads on the elephant-friendly network hit a peak rate of 16 Mbps, decreasing to about 9 Mbps after the videos begin, while giving some room to mice flows too. In the video-friendly scenario, the rate of downloads falls slightly compared to the elephant-friendly scenario at the beginning, and is suppressed heavily as soon as video streaming begins.

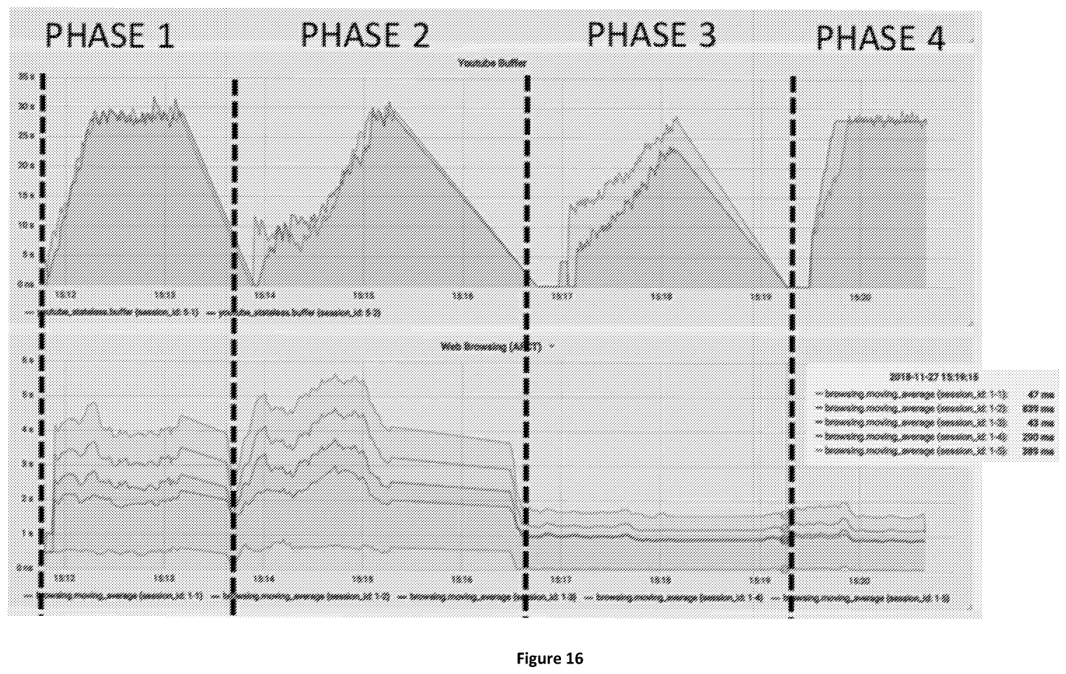

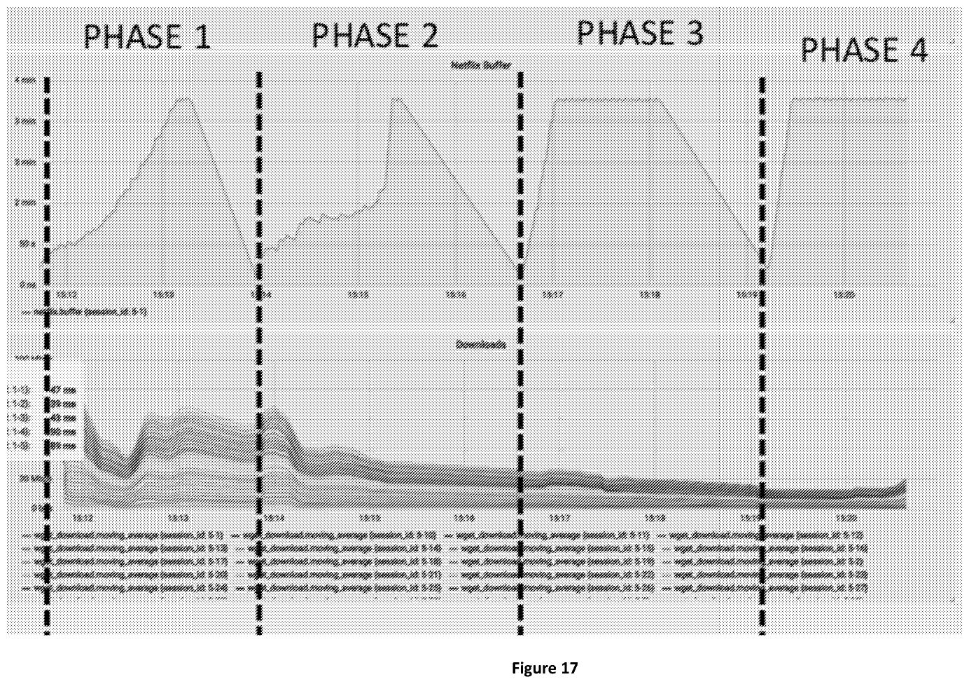

FIGS. 16 and 17 are screenshots showing results from another set of experiments that illustrate the flexibility and benefits of the network bandwidth apportioning system and process described herein. FIG. 16 represents the health of Youtube buffers (top) and web-page load times (bottom left), while FIG. 17 represents Netflix buffers (top) and rate for large downloads (bottom). The experiment was repeated four times—the first experiment set the baseline with an aggregate provisioned bandwidth of 100 Mbps and neutral behavior. In this case, web-page loads average 0.8 seconds, a Youtube 4k video takes 25 seconds to fill its buffers, Netflix plays at 480 p resolution and takes 60 seconds to fill its buffers, while downloads average 60 Mbps. When the aggregate provisioned bandwidth is reduced by 20%, namely to 80 Mbps, performance drops as one would expect: web-pages take 1.1 seconds to load on average, Youtube takes 80 seconds to fill its buffer, Netflix takes 75 seconds, and down-loads get 40 Mbps.

With bandwidth held at 80 Mbps, the next experiment uses the network bandwidth apportioning system and process described herein, with utility curves tuned to achieve weighted priorities in the ratio of 25:50:25 for browsing, video, and downloads, respectively. It is now observed that webpage load time reduces to 0.34 seconds, the Youtube 4k stream takes 60 seconds to fill its buffers, while the Netflix stream is now able to operate at 720 p and takes only 10 seconds to fill its buffers—these performance improvements come at the cost of reducing average download speeds to 20 Mbps. For the final experiment, the utility functions were configured to prioritise video over browsing, and browsing over downloads. In this case, web-page load times average 0.38 seconds, Youtube and Netflix take only 10 and 5 seconds respectively to fill buffers, and downloads are throttled to 15 Mbps. These experiments confirm that the described network bandwidth apportioning system and process can be tuned to greatly enhance performance for browsing and video streams while reducing the aggregate bandwidth requirement, thereby improving user experience while reducing band-width costs.

Many modifications will be apparent to those skilled in the art without departing from the scope of the present disclosure.

1-20 (canceled)

21. A computer-implemented network bandwidth apportioning process executable by at least one processor of an Internet Service Provider (ISP), the process comprising:
accessing utility function data representing, for each of a plurality of mutually exclusive predetermined classes of network traffic, a relationship between a per-subscriber provisioned bandwidth of the class and a deemed utility of the class;
processing the utility function data to determine, for each of the classes, a corresponding portion of network bandwidth to be allocated to the class such that a sum of the deemed utilities for the classes is maximized for the determined portions; and
apportioning network bandwidth of the ISP between the classes in accordance with the determined portions of network bandwidth, wherein the apportioning network bandwidth includes:
(i) inspecting packets of network traffic to classify each of the packets into a corresponding one of the classes, wherein corresponding multiple different flows of network traffic are aggregated into each of the classes; and
(ii) for each said class, allocating network bandwidth to packets of the class in accordance with the determined portion of network bandwidth for the class.

22. The computer-implemented network bandwidth apportioning process of claim 21, wherein the relationships are defined by respective different analytic formulae, and which includes generating display data for displaying the analytic formulae to a network user and sending the display data to a device of the network user in response to a request to view the analytic formulae.

23. The computer-implemented network bandwidth apportioning process of claim 22, wherein the analytic formulae include one or more analytic formulae with one or more of the following forms:
$$\begin{matrix}{U}_{i} = 1 - {e}^{- a ( {x}_{i} - b )} , and & ( i ) \\ {U}_{i} = \frac{1}{( 1 + {e}^{- a ( {x}_{i} - b )} )} , & ( ii )\end{matrix}$$
where Uᵢ represents the deemed utility of class i, xᵢ represents the per-subscriber provisioned bandwidth of the class, and a≠0, b¿0 are constants.

24. The computer-implemented network bandwidth apportioning process of claim 22, wherein the analytic formulae include analytic formulae according to:
Uᵢ(xᵢ)=\sqrt{aᵢxᵢ} and Uⱼ(xⱼ)=\sqrt{aⱼxⱼ},
wherein Uᵢ and Uⱼ represent the deemed utilities of classes i and j, respectively, and aᵢ>0 and aⱼ>0 are constants, wherein class-i's and class-j's bandwidths are balanced when
$$\frac{{a}_{i}}{{x}_{i}} = \frac{{a}_{j}}{{x}_{j}} .$$

25. The computer-implemented network bandwidth apportioning process of claim 22, wherein the analytic formulae include analytic formulae according to:
Uᵢ(xᵢ)=aᵢxᵢ and Uⱼ (xⱼ)=aⱼxⱼ, where aᵢ>aⱼ>0 are constants,
wherein class-i's bandwidth demand is always met before class -j receives any allocation.

26. The computer-implemented network bandwidth apportioning process of claim 21, wherein the classes include a class for mice flows, a class for elephant flows, and a class for streaming video.

27. The computer-implemented network bandwidth apportioning process of claim 21, wherein the classes consist of a class for mice flows, a class for elephant flows, and a class for streaming video.

28. The computer-implemented network bandwidth apportioning process of claim 21, wherein the classes are no more than a few tens in number.

29. At least one computer-readable storage medium having stored thereon processor-executable instructions that, when executed by one or more processors, cause the processors to execute the network bandwidth apportioning process of claim 21.

30. A network bandwidth apportioning system comprising:
one or more network traffic classification components configured to receive packets of network traffic and classify each of the received packets into a corresponding one of a plurality of predetermined mutually exclusive classes of network traffic; and
one or more bandwidth allocation components configured to apportion network bandwidth of the ISP between the classes in accordance with portions of network bandwidth determined by processing utility function data representing, for each of a plurality of classes, a relationship between per-subscriber provisioned bandwidth of the class and a deemed utility of the class, wherein the portions are determined such that a sum of the deemed utilities for the classes is maximized.

31. The network bandwidth apportioning system of claim 30, which includes:
a plurality of traffic simulation components configured to automatically generate different types of network traffic flows in a network to simulate network traffic flows that might be generated by users of the network performing different types of activities; and
a network performance metric generator configured to generate a plurality of different metrics of network performance based on the simulated network traffic flows.

32. The network bandwidth apportioning system of claim 31, wherein the metrics of network performance include one or more of: web page load time, video stalls, and download rate.

33. The network bandwidth apportioning system of claim 32, wherein the metrics of network performance include: web page load time, video stalls, and download rate.

34. The network bandwidth apportioning system of claim 30, wherein the relationships are defined by respective different analytic formulae, and the which includes a display component configured to generate display data for displaying the analytic formulae to a network user and send the display data to a device of the network user in response to receipt of a request to view the analytic formulae.

35. The network bandwidth apportioning system of claim 34, wherein the analytic formulae include one or more analytic formulae with one or more of the following forms:
$$\begin{matrix}{U}_{i} = 1 - {e}^{- a ( {x}_{i} - b )} , and & ( i ) \\ {U}_{i} = \frac{1}{( 1 + {e}^{- a ( {x}_{i} - b )} )} , & ( ii )\end{matrix}$$
where Uᵢ represents the deemed utility of class i, xᵢ represents the per-subscriber provisioned bandwidth of class i, and a≠0, b≠0 are constants.

36. The network bandwidth apportioning system of claim 34, wherein the analytic formulae include analytic formulae according to:
Uᵢ(xᵢ)=\sqrt{aᵢxᵢ} and Uⱼ(xⱼ)=\sqrt{aⱼxⱼ},
wherein Uᵢ and Uⱼ represent the deemed utilities of classes i and j, respectively, and aᵢ>0 and aⱼ>0 are constants, wherein class-i's and class-j's bandwidths are balanced when
$$\frac{{a}_{i}}{{x}_{i}} = \frac{{a}_{j}}{{x}_{j}} .$$

37. The network bandwidth apportioning system of claim 34, wherein the analytic formulae include analytic formulae according to:
Uᵢ(xᵢ)=aᵢxᵢ and Uⱼ(xⱼ)=aⱼxⱼ where aᵢ>aⱼ>0 are constants,
wherein class-i's bandwidth demand is always met before class-j receives any allocation.

38. The network bandwidth apportioning system of claim 30, wherein the classes include a class for mice flows, a class for elephant flows, and a class for streaming video.

39. The network bandwidth apportioning system of claim 30, wherein the classes consist of a class for mice flows, a class for elephant flows, and a class for streaming video.

40. The network bandwidth apportioning system of claim 30, wherein the classes are no more than a few tens in number.
